(19) United States
(12) Patent Application Publication
(10) Pub. No.: US 2020/0280761 A1
(43) Pub. Date: Sep. 3, 2020

(54) AUTOMATED MEASUREMENT OF END-TO-END LATENCY OF VIDEO STREAMS

(71) Applicant: PELCO, Inc., Andover, MA (US)

(72) Inventor: Mathew STAPLES, Fort Collins, CO (US)

(73) Assignee: PELCO, Inc., Andover, MA (US)

(21) Appl. No.: 16/289,863

(22) Filed: Mar. 1, 2019

(51) Int. Cl. H04N 21/438; G06T 7/246; H04N 5/232; H04N 21/2187

(52) U.S. Cl. CPC H04N 21/4384; H04N 21/2187; H04N 5/23299; G06T 7/246

(57) ABSTRACT

A system and method is provided to measure latency on a video management system having a computer system and a camera. The computer system initiates a presentation of a video stream comprising a plurality of video frames on a display device. Each video frame of the video stream includes a changing image which represents frame information for tracking the video frame. The computer system receives a live video stream representative of the presented video stream from the camera, which is directed at an output of the display device to capture in real-time the presented video stream. The image of one or more video frames of the received stream is processed to identify the frame information from the one or more video frames. The end-to-end latency of the video stream is determined based on at least identified frame information of the one or more video frames of the received stream.

### FIELD

The present disclosure is generally directed to testing of video management systems, and more particularly, to measuring latency associated with various operations performed on video management systems.

### BACKGROUND

Users of a video management system (VMS) are often interested in measuring the end-to-end latency of live video streams, as defined by the total time needed for a camera to capture a video frame, encode it, transmit it across a network, decode it on the other end, and finally display it on a computer monitor. This measurement is particularly useful when assessing control performance of cameras that support optical pan, tilt and zoom (PTZ), since long latencies can significantly hamper usability when controlling PTZ cameras over a network.

The traditional method of measuring end-to-end latency can involve providing a high-resolution clock, pointing the camera at that clock, and viewing the live video stream from the camera on the computer screen. The user would then take a picture of both the high-resolution clock and the clock from the live video stream which is displayed on the computer screen. The user could then manually read the time from both sub-images of the picture and subtract the two values to calculate the end-to-end latency. Since there is some variability in this measurement, mainly due to screen refresh time, the user would need to repeat this operation several times to get an averaged value. The traditional manual approach to measuring end-to-end latency and other types of latency in a VMS is, however, time and labor intensive, particularly in video management systems with a large number of cameras.

### SUMMARY

To address these and other shortcomings, systems and methods are provided to automatically measure various types of latency in a video management system (VMS), including latencies associated with video streaming and camera control.

In accordance with an embodiment, systems and methods are provided to measure latency on a video management system having a computer system and one or more cameras. The systems and methods can initiate through the computer system a presentation of a video stream comprising a plurality of video frames on a display device. Each video frame of the video stream can include a changing image which represents frame information for tracking the video frame. The image can be optical machine-readable data, such as a barcode, or QR code. The systems and method can further receive at the computer system a live video stream representative of the presented video stream from at least one camera, which is directed at an output of the display device to capture in real-time the video stream presented on the display device, process the image of one or more video frames of the received live video stream to identify the frame information from the one or more video frames, and determine end-to-end latency of the video stream based on at least identified frame information of the one or more video frames of the received live video stream. The systems and method can store the determined end-to-end latency on a memory, and display the determined end-to-end latency on at least the display device.

In accordance with further embodiments, an average end-to-end latency of the video stream can be determined based on at least the frame information from the image of a plurality of received video frames from the received live video stream. The live video stream can be received from the camera across one or more networks, and the operations of initiating, receiving, processing and determining can be performed by a client application running on the computer system of the video management system. The video stream can be generated, such as in real-time for presentation on the display device or stored for future presentation on the display device.

In accordance with another embodiment, the frame information of each video frame can be associated with a presentation order of the corresponding video frame. To determine end-to-end latency, the systems and methods can determine a frame count representing a number of video frames that have been presented from presentation of a video frame (from the plurality of video frames) to a receipt of a video frame from the received live video stream corresponding to the presented video frame, based on at least the frame information from the image of the video frame from the received live video stream; and can calculate the end-to-end latency according to the frame count.

In accordance with yet another embodiment, the frame information of each video frame can represent a time value of when the video frame is presented on the display device. To determine end-to-end latency, the systems and methods can compare the time value from the frame information of a received video frame from the received live video stream to a time at which the received video frame is received by the computer system.

In accordance with a further embodiment, the systems and method can detect movement of the image from the received live video stream, and determine a camera control latency. For example, the systems and methods can store a first time value at which a command to pan, tilt or zoom the camera is initiated through the computer system, identify a second time value at which the image in the received live video begins to move, determine a total camera control latency according to a time difference between the first time value and the second time value, and subtract the determined end-to-end latency of the video stream from the total camera control latency to determine the camera control latency.

In accordance with another embodiment, the video stream presented on the display device can be captured by a plurality of cameras (including the at least one camera) which are directed toward an output of the display device. Live video stream representative of the captured video stream can be transmitted from each of the plurality of cameras to the computer system. The live video stream from each of the plurality of cameras can be received at the computer system. Frame information from the image of one or more video frames of the live video streams from the plurality of cameras can be identified. The end-to-end latency of the video stream for each of the plurality of cameras can be determined based on at least identified frame information for the one or more video frames of each of the live video streams from the plurality of cameras.

In accordance with a further embodiment, the systems and methods can determine if the end-to-end latency is within predefined limits. In response to determining that the end-to-end latency is not within predefined limits, the systems and methods can identify at least one source of the end-to-end latency. The systems and methods can also determine if the end-to-end latency is capable of being reduced or eliminated, and in response to determining that the end-to-end latency is capable of being reduced or eliminated, can identify at least one means for reducing or eliminating the end-to-end latency. The one or more of the identified at least one means can be applied for reducing or eliminating the end-to-end latency. The at least one means for reducing or eliminating the end-to-end latency can includes: adjusting one or more operational parameters or configuration settings associated with the camera, or adjusting one or more operational parameters or configuration settings associated with one or more networks over which the live video stream from the camera is transmitted.

Additional objects and advantages will be set forth in part in the description which follows, and in part will be obvious from the description, or may be learned by practice of the present disclosure and/or claims. At least some of these objects and advantages may be realized and attained by the elements and combinations particularly pointed out in the appended claims.

It is to be understood that both the foregoing general description and the following detailed description are exemplary and explanatory only and are not restrictive of the invention, as disclosed or claimed. The claims should be entitled to their full breadth of scope, including equivalents.

### DESCRIPTION OF THE FIGURES

The description of the various example embodiments is explained in conjunction with the appended drawings.

FIG. 1 is an overview of components, systems and/or devices of an exemplary video management system to be tested in which the video management system in accordance with an exemplary embodiment of the present disclosure.

FIG. 2 illustrates an example process by which end-to-end latency of a video stream is measured by a computer system associated with a video management system in accordance with an exemplary embodiment of the present disclosure.

FIG. 3 illustrates an example process by which camera control latency is measured by a computer system associated with a video management system in accordance with an exemplary embodiment of the present disclosure.

FIG. 4 illustrates an example process by which a received video frame from a captured live video stream is processed to determine end-to-end latency in accordance with an exemplary embodiment of the present disclosure.

FIG. 5 illustrates an example process by which latency is evaluated to determine further action to be taken on a video management system in accordance with an exemplary embodiment of the present disclosure.

FIGS. 6-9 illustrate example video frames presented on a display device in accordance with an exemplary embodiment of the present disclosure.

FIG. 10 illustrate a video frame from a live video stream, which is captured using a camera directed toward an output of a display device and reflects movement of the image in the live video stream as a result of PTZ camera command, in accordance with an exemplary embodiment of the present disclosure.

FIG. 11 illustrates a block diagram of example components of a computer system, in accordance with an exemplary embodiment of the present disclosure.

### DISCUSSION OF EXAMPLE EMBODIMENTS

Systems and methods are provided to automatically determine different types of latency on a video management system (VMS) having one or more cameras. Examples of the different types of measurable latency on the VMS can include, for example, the following.

An “end-to-end latency” of a video stream can correspond to an elapsed time between light entering a camera and the corresponding image showing up on a display device. Equivalently, an “end-to-end latency” of a video stream can also be the elapsed time between a video stream being presented on a display device by a system in the VMS, a live video stream of the presented video stream being captured by a camera pointed at the output of the display device, and the captured live video stream being received by the system in the VMS. The end-to-end latency can be dependent on network infrastructure, as well as time spent in the camera (e.g., image capture, encoding, transmission onto an IP network), time spent in the client (e.g., reading from the IP network, buffering, decoding, and presentation on a display).

“Total PTZ latency” is an example of total camera control latency and can correspond to an elapsed time from when a command to pan, tilt or zoom is initiated through a computer system of the VMS to when the effect of that action is visible on a display device of the VMS. For example, the elapsed time can cover a time from when a user (or operator) initiates a PTZ control action (e.g., beginning to pan to the right) to when the effect of that action is visible on a display device (e.g., the on-screen video beginning to show the panning motion).

“PTZ control latency” is an example of a camera control latency and can correspond to an elapsed time from when a command to pan, tilt or zoom is initiated through computer system of the VMS to when the command is implemented by the camera. For example, the elapsed time can cover a time from when a user initiates a PTZ command through an input device until the PTZ camera's motors begin to move in response to that command. The total PTZ latency can correspond to the sum of the camera's PTZ control latency and its end-to-end latency. Thus, the PTZ control latency can be calculated by subtracting the end-to-end latency from the total PTZ latency.

To automate measurement of the different types of latency on the VMS, systems and methods can employ a changing image (e.g., a changing image of an object) in the video frames of a video stream, which represents frame information to track the video frames. The image can be optical machine-readable data, such as an image of a clock, barcode, QR code or other computer-readable image. When performing a latency testing on the VMS, the video stream is presented on a display device by a computer system associated with the VMS. A camera of the VMS captures the presented video stream in real time as a live video stream (e.g., in real-time), and encodes and transmits the live video stream to the computer system. The computer system can process the image in the received live video stream to identify the frame information of one or more video frames using computer-vision techniques, and determine an end-to-end latency of the video stream using the identified frame information. The end-to-end latency of the video stream can be measured by subtracting the difference in time between a time value of when a video frame is presented and a time value of when the video frame is received by the computer system, or by counting the number of frames between the presentation of a video frame and the receipt of the video frame by the computer system. The computer system can also detect movement of the image in the live video stream, and determine a camera control latency of a control operation, such as pan, tilt and/or zoom of the camera, associated with the image movement. A number of measurements for each of the different types of latency can be taken to determine a minimum, maximum and/or average measured latency. The latency measurement testing operations can be controlled by a client application operating on the computer system of the VMS. These and other example features of the present disclosure will be described below in further detail with reference to the figures.

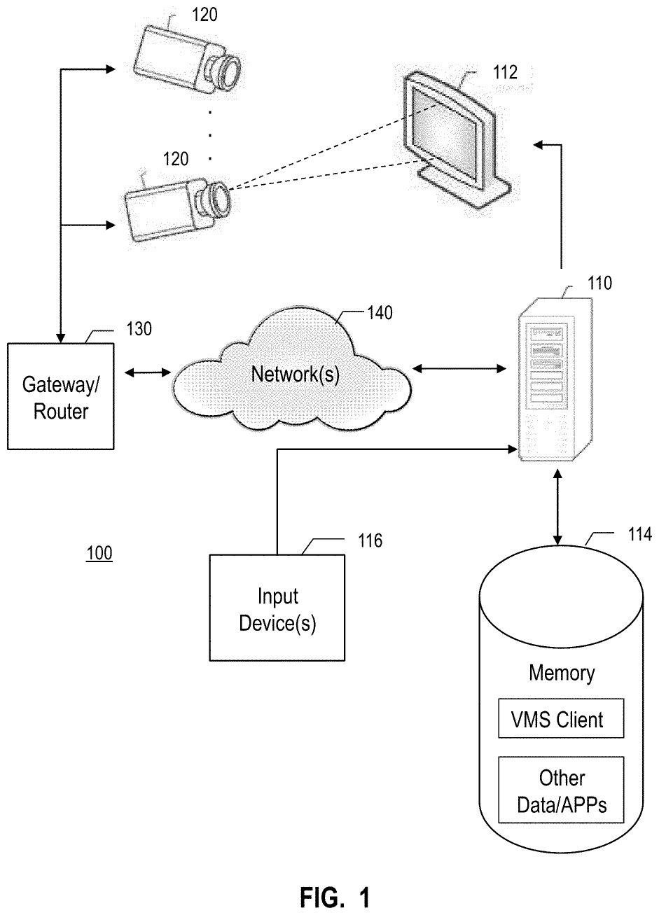

Referring to FIG. 1, there is shown an overview of an example video management system (VMS) 100 to monitor one or more interior or exterior locations. The VMS 100 can include one or more computer system(s) 110, display device(s) 112, memory 114, input device(s) 116, and camera(s) 120, which can communicate using wireline and/or wireless communications in different system configurations. In this example, cameras 120 can communicate with the computer system 100 across one or more network(s) 140 via a gateway/router 130. The network(s) 140 can be a wired and/or wireless network that uses, for example, physical and/or wireless data links to carry network data among (or between) the network nodes.

Each camera 120 can include one or more image sensors for capturing still images or video for storage or streaming (e.g., live streaming). The camera 120 can also include a processor(s) to perform video processing including video encoding, a memory, and a communication device for conducting wireline or wireless communication, such as for example, over the network(s) 140. The camera 120 can be configured to perform various operations, including capturing, storing, encoding, and/or transmitting still images or video such as in the form of a video stream. The camera 120 can also be configured to pan, tilt or zoom (also referred to as PTZ) under manual control or remote control via control commands from the computer system 110 or other systems in the VMS 100. The camera can for example have a frame capture rate of 60 fps (frames per second) or greater.

Before performing latency testing, the camera 120 can be calibrated manually or automatically to an acceptable PTZ position to provide a suitable field of view for capturing video frames and their image displayed on the display device 120. For example, an operator or user can manually control the PTZ of the camera 120 so that the camera 120 is adequately aligned in relations to the output of the display device 112 to capture a video stream (or relevant portion thereof) output from the display device 112. Alternatively, the computer system 110 can perform automatic calibration to align the PTZ position of the camera 120 relative to the output of the display device 112 by controlling the PTZ of the camera 120 in accordance with one or more reference points displayed in a video stream or still image on the display device 112.

The computer system 110 can be a data/control processing system with one or more processors. The computer system 110, through the one or more processors, can be configured to control or perform various operations associated with video management in the VMS 100, including but not limited to: monitoring of one or more locations using the cameras 120; controlling the operations of the cameras 120 (via control commands or signals) including PTZ functions, storage and transmission of captured images and video, and other camera functions; controlling the presentation of video and other information on the display device(s) 112 or other output devices; receiving video and other information from the cameras 120 and other systems in the VMS 100; receiving input commands from the input device(s) 116; performing latency measurement operations; and other operations described herein. The computer system 110 can be a standalone processing system or a distributed processing system including a plurality of computer systems which employ a common or synchronized system clock.

The display device(s) 112 can be any output device for displaying information, such as images, video or other data described herein including latency measurements, alerts and so forth. The display device(s) 112 can also display graphical user interface(s) or GUIs. The display device 112 can be a monitor, display panel, projector or other display device.

The memory 114 can store applications or programs, which when executed by the one or more processors of the computer system 110, perform the various operations described herein for the computer system 110. The memory 114 can also store other data including images, video for streaming, information for each or selected video frames of a video stream including the presentation and receipt time values (e.g., time stamp based on a system clock), a transmission order within a video stream, latency measurements, real-time and history test data, or other data described herein.

The input device(s) 116 can include any user input device such as a mouse, trackball, microphone, touch screen, a joystick, control console, keyboard/pad, touch screen or other device operable by a user. For example, the input device 116 can be operated by a user to perform PTZ control of any one of the cameras 120, to input information, or to control other operations in the computer system 110 and the VMS 100.

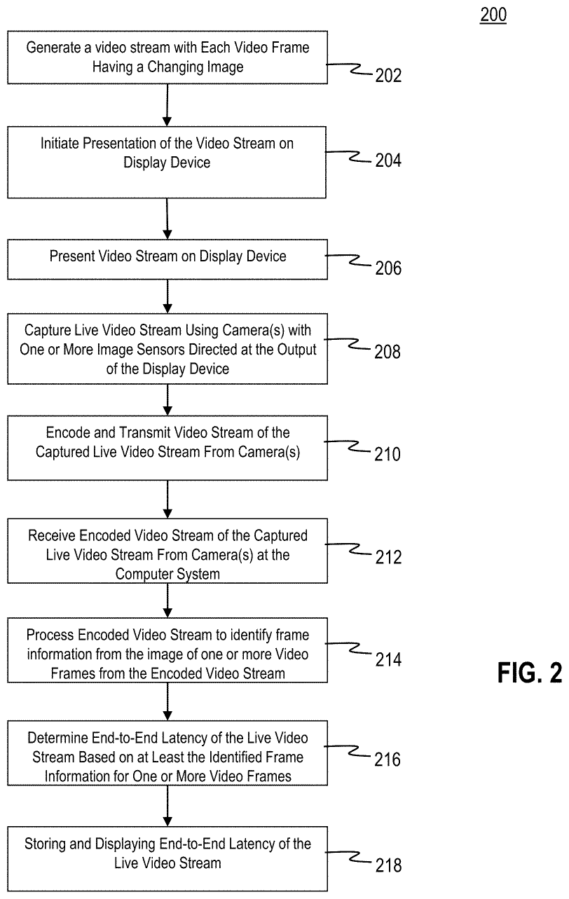

FIG. 2 illustrates an example process 200 by which end-to-end latency of a video stream is measured by a computer system associated with a video management system in accordance with an exemplary embodiment of the present disclosure. By way of example, the process 200 will be described with reference to the VMS 100 in FIG. 1 for the purpose of explanation.

At reference 202, a video stream is generated by the computer system 110. The video to be streamed can include a plurality of video frames (e.g., a sequence of video frames), each of which includes an image located preferably at a fixed or known position in the video frames of the video stream. The image in each video frame changes and represents frame information for tracking the video frame. The image can take the form of optical computer-readable data such as a barcode, QR code or the like which can easily be processed using a code reader to identify the corresponding frame information for a respective video frame, or a clock or other computer-readable image. The optical computer-readable data also does not need to be human-readable, but can be if desired.

The frame information can be a frame identifier which identifies a video frame in a unique fashion, a time value indicating a time at which the video frame is presented, a presentation order value (e.g., frame number 1111 in the sequence of video frames of a video stream), or other information which can be used along with information which is tracked, stored and accessible to the computer system 100 for measuring different types of latency on the VMS 100.

In various embodiments, the computer system 110 or other system in the VMS 100 can generate for presentation, in real-time, video frames with dynamically changing images therein representing their respective frame information, or can access for presentation a pre-generated video of the video frames which can be stored in the memory 114 or other system in the VMS 100. For example, the computer system 110 can overlay the changing image over each of the video frames of the captured live video from the camera 120 for presentation on the display device 112.

At references 204 and 206, the computer system 110 initiates a presentation of the video stream on the display device 112, and the display device 112 presents the video stream on a display screen or other display surface.

At reference 208, the camera 120, which is directed at the output of the display device 112, captures a live video stream indicative of the video stream presented on the display device 112.

At reference 210, the captured live video stream is encoded and transmitted by the camera 120 or other components in communication with the camera 120 on the VMS 100 (e.g., a video encoder and a communication device). Other video processing may also be performed on the captured live video stream prior to transmission to or receipt by the computer system 110.

At reference 212, the computer system 110 receives the encoded, captured live video stream originating from the camera 120. The computer system 110 can decode the live video stream.

At reference 214, the computer system 110 processes the received live video stream to identify frame information from the image of one or more video frames from the received live video stream.

At reference 216, the computer system 110 determines an end-to-end latency of the video stream based on at least the identified frame information for one or more video frames. For example, in one embodiment, the frame information is a time value of when a video frame is presented for display. The computer system 110 is configured to measure the end-to-end latency of the video stream by determining the difference in time from presentation to receipt of a video frame, e.g., subtracting (1) the time value associated with the frame information which represents the presentation time for the video frame from (2) a receipt time value noted by the computer system 110 for the video frame.

In a second embodiment, the frame information is a presentation order value of a video frame in a sequence of video frames (e.g., frame 1, 2, 3 . . . ). The computer system 110 can measure the end-to-end latency of the video stream by determining a frame count reflecting a number of video frames presented from a presentation of a video frame to a receipt of a video frame representing the presented video frame by the computer system 110, using the presentation order value. For example, the computer system can determine a difference between the presentation order value of the received video frame and the presentation order value of a current video frame being presented, or count the number of frames between the received video frame and the current video frame being presented. The end-to-end latency can be the frame count multiplied by the time between successive video frames (e.g., an estimated or average elapsed time between successive video frames of the video stream).

In a third embodiment, the frame information can represent a frame identifier for uniquely identifying a corresponding video frame. The computer system 110 can use the frame identifier along with other information gathered or tracked by the VMS 110 to measure the end-to-end latency of a video stream. For example, the computer system 110 can track and store the time values of when a video frame is presented and received using the frame identifier, and determine the end-to-end latency of a video stream by taking the difference between the time values for presentation and receipt of the video frame. In another example, the computer system 110 can store information relating to a presentation order of the video frames according to their frame identifier, track and store when a video frame is presented and received, and determine the end-to-end latency of a video stream by ascertaining a frame count reflecting a number of video frames presented from when a video frame is presented to when the video frame is received by the computer system 110. As previously noted above, the end-to-end latency can be the frame count multiplied by the time between successive video frames (e.g., an estimated or average elapsed time between the successive video frames of the video stream).

In another example, the computer system 110 can employ a frame counter to keep track of the frame count for one or more selected video frames in the video stream from presentation to receipt. The frame counter for a video frame is for example, incremented for each video frame presented after the presentation of a selected video frame and stops incrementing after receipt of the selected video frame as identified by the frame identifier.

The various embodiments described above are simply provided as examples of how frame information associated with an image in the video frames can be used to keep track of video frames (and information associated therewith) in a video stream and to measure end-to-end latency of a video stream. As reflected from the above examples, the type and amount of information to be maintained in the frame information can be changed to increase or decrease the amount of information that may need to be tracked and stored on the computer system 110 or other system of the VMS 100 in order to measure end-to-end latency.

At reference 218, the measured latency can be stored in memory, and presented on the display device 112 separately or along with the video stream or presented on a different display device in the VMS 100.

Although the process 200 is described with reference to one camera 120, the latency measurement can be performed simultaneously or in parallel for a plurality of cameras 120, which are positioned to capture the output from the same or different display devices. When different display devices are employed, the computer system 110 can broadcast the video stream to multiple display devices at the same time. Furthermore, a plurality of latency measurements can be taken to determine a minimum, maximum and average latency over a period of time or test runs for each camera 120.

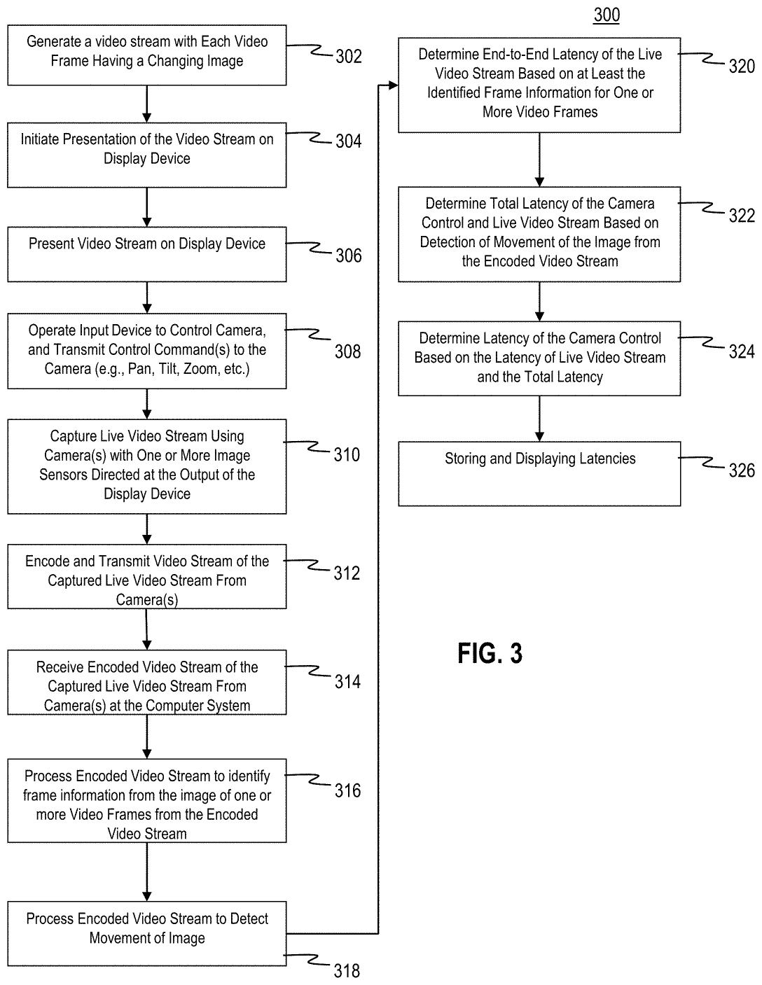

FIG. 3 illustrates an example process 300 by which camera control latency is measured by a computer system associated with a video management system in accordance with an exemplary embodiment of the present disclosure. By way of example, the process 300 will be described with reference to the VMS 100 in FIG. 1 for explanation purposes.

At reference 302, a video stream is generated by the computer system 110. As previously explained, the video to be streamed can include a sequence of video frames, each of which includes an image located preferably at a fixed or known position in the video frames of the video stream. The image in each video frame changes and represents frame information for tracking the video frame. The image can take the form of optical computer-readable data such as a barcode, QR code or the like which can be processed using a code reader to identify the corresponding frame information for a respective video frame, or a clock or other computer-readable image. The optical computer-readable data also does not need to be human-readable, but can be if desired.

In various embodiments, the computer system 110 or other system in the VMS 100 can generate for presentation, in real-time, video frames with dynamically changing images therein representing their respective frame information, or can access a pre-generated video of the video frames which can be stored in the memory 114 or other system in the VMS 100.

At reference 304, the computer system 110 initiates a presentation of the video stream on the display device 112.

At reference 306, the display device 112 presents the video stream on a display screen or other display surface.

At reference 308, while the video stream is being displayed through the display device 112, the computer system 110 can transmit a control command or signals to the camera 120 to perform a pan, tilt and/or zoom operation. The command or control signals can be initiated in response to an operation of the input device 116 by a user or automatically when testing is performed under control of a program or application, such as a client application running on the computer system 110. The computer system 110 can store a first time value reflecting when a camera control operation is initiated.

At reference 310, the camera 120, which is directed at the output of the display device 112, captures a live video stream indicative of the video stream presented on the display device 112.

At reference 312, the captured live video stream is encoded and transmitted by the camera 120 or other components in communication with the camera 120 on the VMS 100 (e.g., a video encoder and a communication device). Other video processing may also be performed on the captured live video stream prior to transmission to or receipt by the computer system 110.

At reference 314, the computer system 110 receives the encoded, captured live video stream originating from the camera 120. The computer system 110 can decode the live video stream.

At reference 316, the computer system 110 processes the received live video stream to identify frame information from the image of one or more video frames from the received live video stream.

At reference 318, the computer system 110 can detect for movement of the image from the received live video frame, and store a second time value reflecting when the movement occurred (e.g., a receipt time of a video frame from the live video stream in which the image has moved with respect to a prior video frame or a known position).

At reference 320, the computer system 110 can determine end-to-end latency of the video stream based on at least the identified frame information for one or more video frames, such as previously described above for FIG. 2.

At reference 322, the computer system 110 can determine a total camera control latency based on the detection of movement of the image from the received live video stream. For example the total camera control latency can be the difference in time between the first time value when camera control is initiated (e.g., PTZ operation) and the second time value when movement is detected (e.g., total camera control latency=second time value−the first time value).

At reference 324, the computer system 110 can determine the camera control latency based on the total latency and the end-to-end latency of the video stream. For example, the camera control latency is equal to the total latency minus the end-to-end latency of the video stream (e.g., camera control latency=total camera control latency−end-to-end latency of the video stream).

At reference 326, the measured latencies can be stored in memory, and presented on the display device 112 separately or along with the video stream or presented on a different display device in the VMS 100.

Although the process 300 is described with reference to one camera 120, the latency measurements can be performed simultaneously or in parallel for a plurality of cameras 120, which are positioned to capture the output from the same or different display devices. When different display devices are employed, the computer system 110 can broadcast the video stream to multiple display devices at the same time. Furthermore, a plurality of latency measurements can be taken to determine a minimum, maximum and average latency over a period of time or test runs for each camera 120.

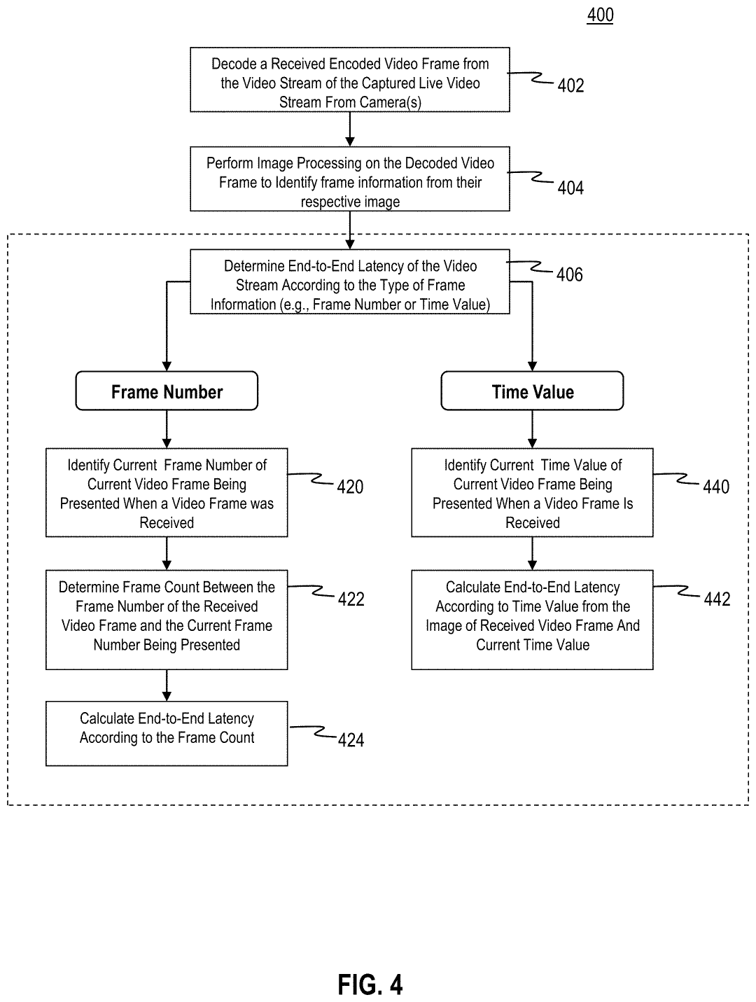

FIG. 4 illustrates an example process 400 by which a received video frame from a captured live video stream is processed to determine end-to-end latency in accordance with an exemplary embodiment of the present disclosure. The process 400 can be an example for implementing the operations of references 214 and 216 of FIG. 2, or the operations of references 316 and 320 of FIG. 3. By way of example, the process 400 will be described with reference to the VMS 100 in FIG. 1 for the purpose of explanation.

The process 400 can be initiated as a video frame (from the live video stream captured by the camera) is received at the computer system 110.

At reference 402, the computer system 110 decodes a received encoded video frame from the video stream of the captured live video stream from the camera 120. At reference 404, the computer system 110 performs image processing on the decoded video frame to identify frame information from the image on the frame.

At reference 406, the computer system 110 determines end-to-end latency of the video stream according to the type of frame information (e.g., Frame Number, Time Value, or etc.) For example, if the frame information is associated with a frame number, the computer system 110 identifies the current frame number of a current video frame being presented when the video frame, which was decoded and processed, was received, at reference 420. The computer system 110 determines a frame count between the frame number associated with the processed image from the received video frame and the current frame being presented, at reference 422. The computer system 110 can thereafter determine the end-to-end latency of the video frame according to the frame count. For instance, the end-to-end latency can equal the frame count multiplied by the elapsed time between two sequential frames (or between each frame count).

If the frame information is associated with a time value, the computer system 110 identifies a current time value of a current video frame being presented when the video frame, which was decoded and processed, was received, at reference 440. The computer system 110 can thereafter determine the end-to-end latency of the video frame according to the time value associated with the processed image from the received video frame and the current time value. For instance, the end-to-end latency can equal the difference between the current time value and the time value from the image of the received video frame.

The process 400, as described above, provides a few examples for determining end-to-end latency of a video stream. Other types of frame information may be employed to determine end-to-end latency of a video stream.

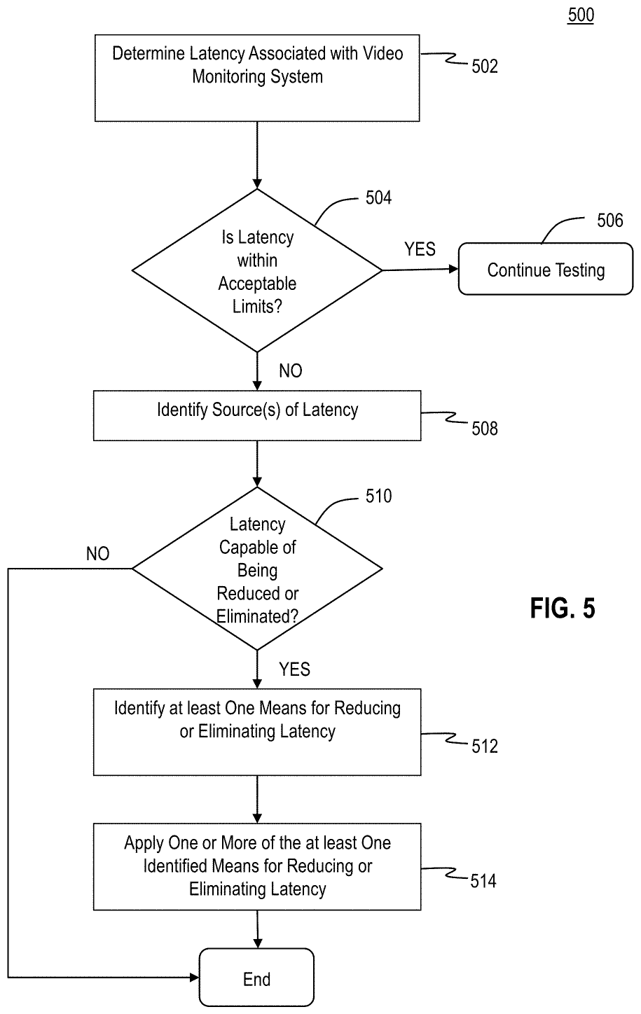

FIG. 5 illustrates an example process 500 by which a measured latency is evaluated to determine whether to take further action on the video management system in accordance with an exemplary embodiment of the present disclosure. The measured latency can be a single latency measurement or an average of a plurality of latency measurements taken over time.

The process 500 can be initiated after a latency is measured, such as for example an end-to-end latency of a video stream, a total camera control latency or a camera control latency, at reference 502.

At reference 504, the computer system 110 determines whether the measured latency is within acceptable limits (e.g., within an acceptable threshold or condition). If so, the computer system 110 can continue latency testing such as described in the process 200 and 300 of FIGS. 2 and 3 at reference 506. If the measured latency is not within acceptable limits, the computer system 110 proceeds to identify a source(s) of the measured latency at reference 508. For example, the computer system 110 can perform various system diagnostics on VMS 100 to check if the latency is due to the computer system 110, the display device 112, the memory 114, the input device(s) 116, the camera 120, the gateway/router 130, the communication network 140 or other components of or associated with the VMS 100.

At reference 510, the computer system 110 can determine whether the latency can be reduced or eliminated depending on the identified source(s) of the measured latency. If not, the process 500 ends. Otherwise, if the latency can be reduced or eliminated, the computer system 110 can identify at least one means to reduce or eliminate the measured latency at reference 512, and apply such means to reduce or eliminate the measured latency at reference 514. For example, one means for reducing or eliminating a latency can include adjusting one or more operational parameters or configuration settings associated with the camera 120 or the VMS 100 through the computer system 110 or other computer system of the VMS 100. If the video stream or camera control command/signal is transmitted over one or more networks from the camera 120, the means for reducing or eliminating the latency can include adjusting one or more operational parameters or configuration settings associated with at least one of the one or more networks through the computer system 110 or other system of the VMS 100. Thereafter, the process 500 can end.

The computer system 110 can re-test the VMS 100 to measure the various latencies using the processes 200 and/or 300 of FIGS. 2 and 3, and evaluate the measured latencies to determine if they are within acceptable limits using the process 500 of FIG. 5 again. The results can be stored as test data in a testing history along with the measured latencies, any associated actions and time/date the testing occurred, and the stored information can be outputted to a user.

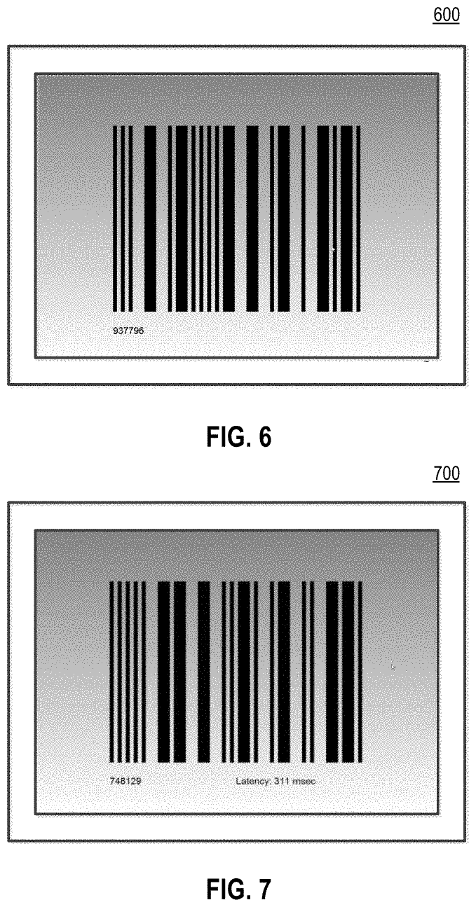

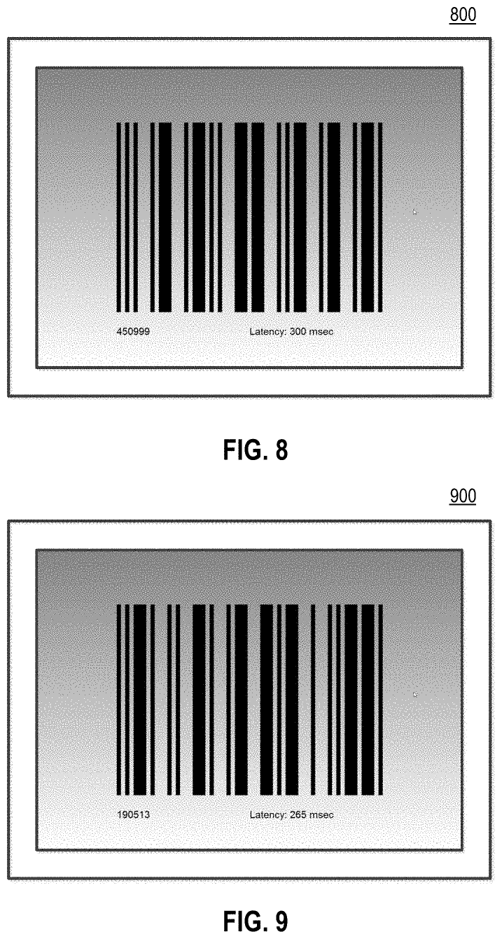

FIGS. 6-9 illustrate example video frames of a video stream displayed on a display device and/or captured by a camera in accordance with an exemplary embodiment of the present disclosure. In these examples, the video frames 600, 700, 800 and 900 each include an image in the form of an optical computer-readable data, such as a barcode, which represents frame information. The video frames 700, 800 and 900 of FIGS. 7-9 can also incorporate an indication of a measured latency in real-time for display along with the video stream on a display device.

The changing image in the video frames or the video stream can be provided in a separate graphical window or screen portion for presentation on the display device, and the position and the dimensions of the image, window or screen portion can be adjusted or calibrated to facilitate video capture by one or more cameras. The same or other windows or screen portions can be used to simultaneously display other types of data (such as measured latency, alerts when the measured latency is outside acceptable limits, real-time and historical test data, and other information described herein), or graphical user interface (GUI) to initiate/re-initiate and control latency testing operations and/or to adjust operational parameters or configuration settings on the VMS, including the camera, computer system, display device, input device, network or other VMS components, to reduce or eliminate latency under certain conditions (e.g., when a measured latency is outside acceptable limits). The GUI can include graphical buttons, sliders, textbox, pull down box, check box, and/or other graphical inputs to perform the above-noted operations along with others described herein.

Furthermore, in the example in which the captured live video stream is presented on the display device, the new changing image may be placed over a predefined location or region of the video frame to be presented or a graphical window or screen portion which presents the video stream in order to cover/replace the old image in the received live video stream captured by the camera.

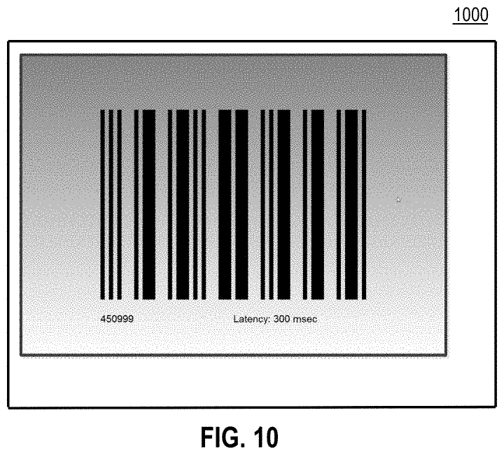

FIG. 10 shows a video frame from a live video stream, which is captured using a camera that is directed toward an output of a display device, and reflects movement of the camera such as pan, tilt and/or zoom operation, in accordance with an exemplary embodiment of the present disclosure. In FIG. 10, the position of the image (e.g., a barcode) of the captured video frame has moved relative to the image in a prior captured video frame (see, e.g., 600, 700, 800 and 900 of FIGS. 6-9) or to a known position. The computer system 110 can employ an object tracking algorithm to identify and track movement of an image in the video frames of a video stream.

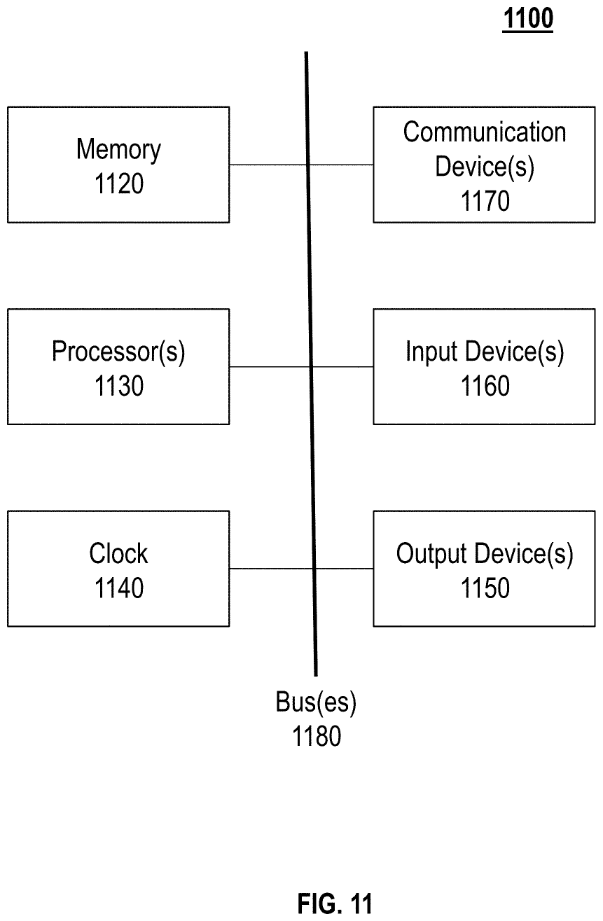

As shown in FIG. 11, a computer system 1100 can include for example memory 1120, processor(s) 1130, clock 1140, output device 1150, input device 1160, communication device 1170, and a bus system 1080 between the components of the computer system. The clock 1140 can be used to time-stamp data or an event with a time value, such as when data is presented/outputted on a display device, transmitted or received, or when an event is detected. For example, time values can also be stored to identify when a particular or selected or each video frame(s) from a video stream is presented, transmitted or received. The clock 1040 can be a system clock or synchronized to a system clock for a VMS.

The memory 1120 can store computer executable code, programs, software or instructions, which when executed by a processor, controls the operations of the computer system 1100, including the various processes described herein. The memory 1120 can also store other data used by the computer system 1100 or components thereof to perform the operations described herein. The other data can include but is not limited to video stream to be presented, time values to identify when a particular or selected video frame(s) is presented or received, a frame count or counter for a particular or selected video frame(s) for use in determining a number of frames that have been presented between the presentation of a video frame and the receipt of the video frame, test data including measured latency (e.g., end-to-end latency of a video stream, total camera control latency, camera control latency or other types of latency related information described herein), and other data described herein.

The output device(s) 1150 can include a display device, printing device, speaker, lights (e.g., LEDs) and so forth. For example, the output device(s) 1150 may output for display or present a video stream, graphical user interface (GUI) or other data.

The input device(s) 1160 can include any user input device such as a mouse, trackball, microphone, touch screen, a joystick, control console, keyboard/pad, touch screen or other device operable by a user. The input device 1160 can be configured among other things to remotely control the operations of one or more cameras, such as pan, tilt and/or zoom operations. The input device(s) 1160 may also accept data from external sources, such other devices and systems.

The processor(s) 1130, which interacts with the other components of the computer system, is configured to control or implement the various operations described herein. These operations can include generating video frames with desired image(s) for a video stream, processing video frames to identify frame information from the image of the video frames; controlling presentation of data on a display device including the presentation of video frames of a video stream; transmitting and receiving video frames of a video stream; communicating with one or more cameras; controlling one or more cameras via commands; determining, storing, outputting/presenting or transmitting different types of latency information including but not limited to end-to-end latency of a video stream, total camera control latency, camera control latency, and other latency related information.

The above describes example components of a computer system such as a computer, server or other data processing system, which may communicate with one or more cameras and/or display systems with a display device over a network(s). The output device and input devices 1150 and 1160 respectively may communicate with the processor 1130 over a local bus or a network. The computer system may be a distributed processing system, which includes a plurality of computer systems which can operate under a common or synchronized system clock.

### EXAMPLES

To measure different types of latency in a VMS with one or more cameras, at least one of the cameras is directed toward a display device to capture the output from the display device. A computer system of the VMS receives the captured video stream from the camera and presents the captured video stream on the display device. A VMS client operation, which can be implemented through the computer system, can then be initiated to provide an image of a running clock, which is also presented on the display device over the live video stream captured by the camera. Using computer-vision techniques, the VMS client can read the clock value from the live video stream captured by the camera. The clock does not necessarily need to be displayed in a human-readable format, but instead can be displayed as a barcode, QR code, or other computer-friendly format to enable the VMS client to efficiently read the clock value from the captured live video stream (e.g., using bar or QR code reader). The VMS client can thereafter calculate the end-to-end latency of that video stream by subtracting the clock value of when a video frame is received from the clock value associated with the image in the received video frame. In this example, the frame rate of the presented video stream is based on the frame rate of the camera, which can for example be 60 fps or higher.

Instead of using an image of a running clock, the VMS client can generate an image of a running sequence of different codes such as a barcode or QR code for display. The VMS client can read the image of the code received from the live video stream captured by the camera using a code reader, and can determine a frame count between the current code presented on the display device and the current code received from the live video stream. The VMS client can thereafter calculate the end-to-end latency of the video stream by multiplying the frame count by the elapsed time between each frame. An average elapsed time between frames on the VMS can be used for the calculation. A running counter can be used to provide sequential frame numbers associated with the different codes for the video frames.

To measure the PTZ control-latency, computer-vision techniques are used once again to measure the position of the image (e.g., the “clock”, barcode, etc.) within the frames of the video stream. Since PTZ control operations can be generated from the same VMS client application that interprets the camera's video stream, the system time of PTZ input events (e.g., movement of a joystick) can be recorded. Provided that the camera's PTZ motion keeps the clock within the camera's field of view, the system time at which the clock's motion is detected in the video stream can also be recorded. The difference between these two system times is the total PTZ latency, which is the PTZ control-latency plus the end-to-end latency of the camera. Subtracting the end-to-end latency from the total PTZ latency provides an automatic calculation of the PTZ control-latency.

It should also be understood that the example embodiments disclosed and taught herein are susceptible to numerous and various modifications and alternative forms. Thus, the use of a singular term, such as, but not limited to, “a” and the like, is not intended as limiting of the number of items. Furthermore, the naming conventions for the various components, functions, characteristics, thresholds, and other elements used herein are provided as examples, and can be given a different name or label. The use of the term “or” is not limited to exclusive “or”, but can also mean “and/or”.

It will be appreciated that the development of an actual, real commercial application incorporating aspects of the disclosed embodiments will require many implementation specific decisions to achieve the developer's ultimate goal for the commercial embodiment. Such implementation specific decisions may include, and likely are not limited to, compliance with system related, business related, government related and other constraints, which may vary by specific implementation, location and from time to time. While a developer's efforts might be complex and time consuming in an absolute sense, such efforts would nevertheless be a routine undertaking for those of skill in this art having the benefit of this disclosure.

Using the description provided herein, the example embodiments may be implemented as a machine, process, or article of manufacture by using standard programming and/or engineering techniques to produce programming software, firmware, hardware or any combination thereof.

Any resulting program(s), having computer-readable program code, may be embodied on one or more computer-usable media such as resident memory devices, smart cards or other removable memory devices, or transmitting devices, thereby making a computer program product or article of manufacture according to the embodiments. As such, the terms “article of manufacture” and “computer program product” as used herein are intended to encompass a computer program that exists permanently or temporarily on any computer-usable medium or in any transmitting medium which transmits such a program.

A processor(s) or controller(s) as described herein can be a processing system, which can include one or more processors, such as CPU, GPU, controller, FPGA (Field Programmable Gate Array), ASIC (Application-Specific Integrated Circuit) or other dedicated circuitry or other processing unit, which controls the operations of the devices or systems, described herein. Memory/storage devices can include, but are not limited to, disks, solid state drives, optical disks, removable memory devices such as smart cards, SIMs, WIMs, semiconductor memories such as RAM, ROM, PROMS, etc. Transmitting mediums or networks include, but are not limited to, transmission via wireless communication (e.g., Radio Frequency (RF) communication, Bluetooth®, Wi-Fi, Li-Fi, etc.), the Internet, intranets, telephone/modem-based network communication, hard-wired/cabled communication network, satellite communication, and other stationary or mobile network systems/communication links. Video may streamed using various protocols, such as for example HTTP (Hyper Text Transfer Protocol) or RTSP (Real Time Streaming Protocol) over an IP network. The video stream may be transmitted in various compression formats (e.g., JPEG, MPEG-4, etc.)

While particular embodiments and applications of the present disclosure have been illustrated and described, it is to be understood that the present disclosure is not limited to the precise construction and compositions disclosed herein and that various modifications, changes, and variations can be apparent from the foregoing descriptions without departing from the invention as defined in the appended claims.

1. A method of measuring latency on a video management system having a computer system and one or more cameras, the method comprising:
initiating through the computer system a presentation of a video stream comprising a plurality of video frames on a display device, each video frame of the video stream including a changing image which represents frame information for tracking the video frame;
receiving at the computer system a live video stream representative of the presented video stream from at least one camera, which is directed at an output of the display device to capture in real-time the video stream presented on the display device;
processing the image of one or more video frames of the received live video stream to identify the frame information from the one or more video frames; and
determining end-to-end latency of the video stream based on at least identified frame information of the one or more video frames of the received live video stream.

2. The method of claim 1, wherein the frame information of each video frame is associated with a presentation order of the corresponding video frame, the determining end-to-end latency comprising:
determining a frame count representing a number of video frames that have been presented from presentation of a video frame from the plurality of video frames to a receipt of a video frame from the received live video stream corresponding to the presented video frame, based on at least the frame information from the image of the video frame from the received live video stream; and
calculating the end-to-end latency according to the frame count.

3. The method of claim 1, wherein the frame information of each video frame represents a time value of when the video frame is presented on the display device, the determining end-to-end latency comprising:
comparing the time value from the frame information of a received video frame from the received live video stream to a time at which the received video frame is received by the computer system.

4. The method of claim 1, wherein the determining end-to-end latency comprises:
determining an average end-to-end latency of the video stream based on at least the frame information from the image of a plurality of received video frames from the received live video stream.

5. The method of claim 1, the method further comprising:
detecting movement of the image from the received live video stream; and
determining a camera control latency.

6. The method of claim 5, wherein the determining a camera control latency comprises:
storing a first time value at which a command to pan, tilt or zoom the camera is initiated through the computer system;
identifying a second time value at which the image in the received live video begins to move;
determining a total camera control latency according to a time difference between the first time value and the second time value; and
subtracting the determined end-to-end latency of the video stream from the total camera control latency to determine the camera control latency.

7. The method of claim 1, wherein the live video stream is received from the camera across one or more networks, and the operations of initiating, receiving, processing and determining are performed by a client application running on the computer system of the video management system.

8. The method of claim 1, wherein the image of each video frame of the video stream comprises optical machine-readable data.

9. The method of claim 1, further comprising:
generating the video stream for presentation on the display device.

10. The method of claim 1, wherein the video stream presented on the display device is captured by a plurality of cameras including the at least one camera which are directed toward an output of the display device,
live video stream representative of the captured video stream is transmitted from each of the plurality of cameras to the computer system,
the live video stream from each of the plurality of cameras is received at the computer system,
frame information from the image of one or more video frames of the live video streams from the plurality of cameras are identified, and
end-to-end latency of the video stream for each of the plurality of cameras is determined based on at least identified frame information for the one or more video frames of each of the live video streams from the plurality of cameras.

11. The method of claim 1, further comprising:
determining if the end-to-end latency is within predefined limits; and
in response to determining that the end-to-end latency is not within predefined limits, identifying at least one source of the end-to-end latency.

12. The method of claim 11, further comprising:
determining if the end-to-end latency is capable of being reduced or eliminated;
in response to determining that the end-to-end latency is capable of being reduced or eliminated, identifying at least one means for reducing or eliminating the end-to-end latency; and
applying one or more of the identified at least one means for reducing or eliminating the end-to-end latency.

13. The method of claim 12, wherein the at least one means for reducing or eliminating the end-to-end latency includes:
adjusting one or more operational parameters or configuration settings associated with the camera, or
adjusting one or more operational parameters or configuration settings associated with one or more networks over which the live video stream is transmitted from the at least one camera.

14. The method of claim 1, further comprising:
storing the determined end-to-end latency on a memory; and
displaying the determined end-to-end latency on at least the display device.

15. A system for of measuring latency on a video management system having a computer system and one or more cameras, the system comprising:
memory;
a display device for outputting a video stream;
at least one camera; and
a computer system, including one or more processors, configured:
to initiate a presentation of a video stream comprising a plurality of video frames on the display device, each video frame of the video stream including a changing image which represents frame information for tracking the video frame;
to receive a live video stream representative of the presented video stream from the at least one camera, which is directed at an output of the display device to capture in real-time the video stream presented on the display device;
to process the image of one or more video frames of the received live video stream to identify the frame information from the one or more video frames; and
to determine end-to-end latency of the video stream based on at least identified frame information of the one or more video frames of the received live video stream.

16. The system of claim 15, wherein the frame information of each video frame is associated with a presentation order of the corresponding video frame, to determine end-to-end latency the computer system being configured:
to determine a frame count representing a number of video frames that have been presented from presentation of a video frame from the plurality of video frames to a receipt of a video frame from the received live video stream corresponding to the presented video frame, based on at least the frame information from the image of the video frame from the received live video stream; and
to calculate the end-to-end latency according to the frame count.

17. The system of claim 15, wherein the frame information of each video frame represents a time value of when the video frame is presented on the display device, to determine end-to-end latency the computer system being configured:
to compare the time value from the frame information of a received video frame from the received live video stream to a time at which the received video frame is received by the computer system.

18. The system of claim 15, wherein, to determine end-to-end latency, the computer system is configured:
to determine an average end-to-end latency of the video stream based on at least the frame information from the image of a plurality of received video frames from the received live video stream.

19. The system of claim 15, wherein the camera is configured to pan, tilt or zoom according to a command from the computer system, the computer system is configured:
to detect movement of the image from the received live video stream; and
to determine a camera control latency.

20. The system of claim 19, wherein, to determine a camera control latency, the computer system is configured:
to store a first time value at which a command to pan, tilt or zoom the camera is initiated through the computer system;
to identify a second time value at which the image in the received live video begins to move;
determine a total camera control latency according to a time difference between the first time value and the second time value; and
to subtract the determined end-to-end latency of the video stream from the total camera control latency to determine the camera control latency.

21. The system of claim 15, wherein the live video stream is received from the camera across one or more networks, and the operations to initiate, receive, process and determine are performed by a client application running on the computer system of the video management system.

22. The system of claim 15, wherein the image of each video frame of the video stream comprises optical machine-readable data.

23. The system of claim 15, wherein the computer system is further configured:
to generate the video stream for presentation on the display device.

24. The system of claim 15, wherein the video stream presented on the display device is captured by a plurality of cameras including the at least one camera which are directed toward an output of the display device,
live video stream representative of the captured video stream is transmitted from each of the plurality of cameras to the computer system,
the live video stream from each of the plurality of cameras is received at the computer system,
frame information from the image of one or more video frames of the live video streams from the plurality of cameras are identified, and
end-to-end latency of the video stream for each of the plurality of cameras is determined based on at least identified frame information for the one or more video frames of each of the live video streams from the plurality of cameras.

25. The system of claim 15, wherein the computer system is further configured:
to determine if the end-to-end latency is within predefined limits; and
to identify at least one source of the end-to-end latency in response to determining that the end-to-end latency is not within predefined limits.

26. The system of claim 25, wherein the computer system is further configured:
to determine if the end-to-end latency is capable of being reduced or eliminated;
to identify at least one means for reducing or eliminating the end-to-end latency in response to determining that the end-to-end latency is capable of being reduced or eliminated; and
to apply one or more of the identified at least one means for reducing or eliminating the end-to-end latency.

27. The system of claim 26, wherein the at least one means for reducing or eliminating the end-to-end latency includes:
to adjust one or more operational parameters or configuration settings associated with the camera, or
to adjust one or more operational parameters or configuration settings associated with one or more networks over which the live video stream is transmitted from the at least one camera.

28. The system of claim 1, wherein the computer system is further configured:
to store the determined end-to-end latency on a memory; and
to display the determined end-to-end latency on at least the display device.

29. A tangible computer medium storing computer executable code, which when executed by one or more processors of a computer system, is configured to implement a method of measuring latency on a video management system having one or more cameras, the method comprising:
initiating a presentation of a video stream comprising a plurality of video frames on a display device, each video frame of the video stream including a changing image which represents frame information for tracking the video frame;
receiving a live video stream representative of the presented video stream from at least one camera, which is directed at an output of the display device to capture in real-time the video stream presented on the display device;
processing the image of one or more video frames of the received live video stream to identify the frame information from the one or more video frames; and
determining end-to-end latency of the video stream based on at least identified frame information of the one or more video frames of the received live video stream.
